(19) United States
(12) Patent Application Publication
(10) Pub. No.: US 2016/0210418 A1
(43) Pub. Date: Jul. 21, 2016

(54) MEDICAL SUPPORT DEVICE, METHOD FOR CONTROLLING MEDICAL SUPPORT DEVICE, AND MEDICAL SUPPORT SYSTEM

(71) Applicant: FUJIFILM Corporation, Tokyo (JP)

(72) Inventors: Yasunori OHTA, Ashigarakami-gun (JP); Satoshi UEDA, Tokyo (JP); Yuya KUDO, Tokyo (JP); Hironori MATSUMASA, Tokyo (JP)

(73) Assignee: FUJIFILM Corporation, Tokyo (JP)

(21) Appl. No.: 15/083,627

(22) Filed: Mar. 29, 2016

Related U.S. Application Data
(63) Continuation of application No. PCT/JP2014/074387, filed on Sep. 16, 2014.

(30) Foreign Application Priority Data
Sep. 30, 2013 (JP) 2013-204299

(51) Int. Cl. G06F 19/00

(52) U.S. Cl. CPC G06F 19/326

(57) ABSTRACT

A material search unit searches for an old medical material corresponding to a new medical material from a material correspondence information DB. A clinical path information search unit searches for clinical path information in which the new and old medical materials are used for medical care from the clinical path information DB, and a record information acquisition unit acquires the number of days of hospitalization indicating treatment effects of the new and old medical materials from the clinical path information which has been searched for. An introduction effect analysis unit calculates the average numbers of days of hospitalization of the new and old medical materials, and divides the average number of days of hospitalization of the old medical material by the average number of days of hospitalization of the new medical material, to calculate a rate of a decrease in the average number of days of hospitalization of the new medical material relative to the old medical material as introduction effects of the new medical material.

### CROSS-REFERENCE TO RELATED APPLICATIONS

This application is a Continuation of PCT International Application No. PCT/JP2014/074387 filed on Sep. 16, 2014, which claims priority under 35 U.S.C. §119(a) to Japanese Patent Application No. 2013-204299 filed Sep. 30, 2013. The above application is hereby expressly incorporated by reference, in its entirety, into the present application.

### BACKGROUND OF THE INVENTION

1. Field of the Invention

The present invention relates to a medical support device, a method for controlling the medical support device, and a medical support system that analyze effects of introduction of a medical material.

2. Description Related to the Prior Art

In recent years, in medical institutions such as hospitals, a clinical path is introduced in order to improve the quality and efficiency of medical care. The clinical path is a medical care schedule table in a chart form that represents standardized medical care content for each disease. Since a plurality of medical care scheduled items such as medical examination, treatment, and test are set along a time axis according to a type of disease in the clinical path in advance, it is possible to simply create a medical care schedule of a patient. Since medical care items necessary for each disease become clear due to the clinical path, the quality and efficiency of the medical care is improved by performing medical care of the patient based on the clinical path. Further, the clinical path is used for confirmation of the medical care scheduled items. Further, medical care information on specific content, results, or the like of medical examination, treatment, and test performed on the patient is recorded in the clinical path, which is also used for management of medical care record of the patient.

In medical institutions, a medical material such as a medical device or a drug is newly introduced, or an old medical material is appropriately replaced with a new one. Since the new medical material has been enhanced as compared with a conventional one, various introduction effects such as a decrease in the number of days of hospitalization or the number of days of hospital visit, and normalization of test results of medical test can be obtained. Thus, in a case in which a new medical material has been introduced, content of a medical care scheduled item of a clinical path or a medical care schedule is changed according to the new medical material.

Incidentally, in medical institutions, in a case in which a new medical material is introduced, quantifying the introduction effects has conventionally been desired. If the introduction effects of the medical material can be quantified, the introduction effects can be referred to, for example, when it is determined whether the introduction results are good or when a new medical material is introduced. JP2001-319041A discloses a management support system that data-analyzes record information collected from a medical institution using a benchmarking scheme and provides a result of the analysis to the medical institution. In this management support system, the average number of days of hospitalization of a patient can be presented as a result of the data analysis so that the average number can be compared with that in another hospital. For example, if the average numbers of days of hospitalization before and after introduction of a medical material are compared, effects of introduction of a new medical material can be recognized.

In the management support system disclosed in JP2001-319041A, various information such as receipt information, discharge summary, payroll data, income data, ordering data, and electronic medical record data is collected as record information, and this record information is analyzed in order to obtain the average number of days of hospitalization. Accordingly, since the average number of days of hospitalization obtained as a result of analysis of the record information is changed according to a medical skill of a doctor or a nurse responsible for medical care or a type of a selected method of treatment, accurate introduction effects of a medical material cannot be analyzed in the management support system in JP2001-319041A.

### SUMMARY OF THE INVENTION

An object of the present invention is to provide a medical support device, a method for controlling the medical support device, and a medical support system capable of analyzing effects of introduction of a newly introduced medical material.

In order to solve the above problem, a medical support device of the present invention includes a material correspondence information storage unit, a clinical path information storage unit, an operation reception unit, a material search unit, a clinical path information search unit, a record information acquisition unit, and an introduction effect analysis unit. In the material correspondence information storage unit, identification information of a first medical material and identification information of a second medical material used prior to introduction of the first medical material are stored in association with each other. In the clinical path information storage unit, clinical path information including a medical care schedule of a patient, medical care information on medical care performed on the patient, and the identification information of the first medical material or the second medical material used for the medical care as one of the medical care information is stored. The operation reception unit receives an analysis request of introduction effects of the first medical material on a clinical path display screen on which the medical care schedule, the medical care information, and the identification information of the first medical material as one of the medical care information are displayed. The material search unit searches for the second medical material corresponding to the first medical material received by the operation reception unit from the material correspondence information storage unit. The clinical path information search unit searches for first clinical path information in which the first medical material received by the operation reception unit is used for medical care, and second clinical path information in which the second medical material searched for by the material search unit is used for medical care from the clinical path information storage unit. The record information acquisition unit acquires first record information and second record information indicating treatment effects of the first medical material and the second medical material from the first clinical path information and the second clinical path information. The introduction effect analysis unit compares the first record information with the second record information to analyze the effects of introduction of the first medical material.

It is preferable for the clinical path information to be classified for each disease name or attribute of the patient in the clinical path information storage unit. It is preferable for the clinical path information search unit to search for the first clinical path information and the second clinical path information for each attribute. It is preferable for the record information acquisition unit to acquire the first record information and the second record information for each attribute. It is preferable for the introduction effect analysis unit to analyze the effects of introduction of the first medical material for each attribute.

It is preferable for the first record information and the second record information to be any one of the number of days of hospitalization, the number of days of hospital visit, and a test value of medical test performed on the patient. It is preferable for the introduction effect analysis unit to divide the second record information by the first record information to obtain the effects of introduction of the first medical material relative to the second medical material. It is preferable for the attribute of the patient to include at least one of gender, age, and a body measurement value.

It is preferable for the medical support device to further include a screen creation unit that creates the clinical path display screen and an introduction effect display screen on which introduction effects of the first medical material are displayed. It is preferable for the screen creation unit to create a graph in which the first record information and the second record information are compared with each other, and display the graph on the introduction effect display screen. The screen creation unit may display values of the first record information and the second record information together with the graph. It is preferable for the medical support device to further include a distribution unit that distributes the clinical path display screen and the introduction effect display screen to a client terminal connected over a network.

A method for controlling a medical support device of the present invention analyzes effects of introduction of a first medical material through a comparison with a second medical material used prior to the introduction of the first medical material. The method of controlling a medical support device includes an operation reception step, a material search step, a clinical path information search step, a record information acquisition step, and an introduction effect analysis step. The operation reception step receives an analysis request of the introduction effects of the first medical material on a clinical path display screen on which clinical path information including a medical care schedule of a patient, medical care information on medical care performed on the patient, and identification information of the first medical material or the second medical material used for the medical care as one of the medical care information is displayed. The material search step searches for the second medical material corresponding to the first medical material received in the operation reception step from a material correspondence information storage unit in which identification information of the first medical material and identification information of the second medical material are stored in association with each other. The clinical path information search step searches for first clinical path information in which the first medical material received in the operation reception step is used for medical care, and second clinical path information in which the second medical material searched for in the material search step is used for medical care, from a clinical path information storage unit in which the clinical path information is stored. The record information acquisition step acquires first record information and second record information indicating treatment effects of the first medical material and the second medical material from the first clinical path information and the second clinical path information. The introduction effect analysis step compares the first record information with the second record information to analyze the effects of introduction of the first medical material.

A medical support system of the present invention includes a medical support device, and a client terminal connected to the medical support device over a network. The medical support device includes a screen distribution unit that distributes a clinical path display screen to the client terminal, and an analysis result distribution unit that distributes results of the analysis of the introduction effects to the client terminal, in addition to a material correspondence information storage unit, a clinical path information storage unit, an operation reception unit, a material search unit, a clinical path information search unit, a record information acquisition unit, and an introduction effect analysis unit.

According to the present invention, it is possible to acquire treatment effects of the newly introduced first medical material and treatment effects of the second medical material used prior to introduction of the first medical material from the clinical path information, and analyze the effects of introduction of the first medical material by comparing the acquired treatment effects. In the clinical path information, since content of the medical care scheduled item or the medical care schedule is changed due to the introduction of the new first medical material, it is possible to analyze accurate introduction effects of the first medical material by using treatment effects acquired from the clinical path information.

### BRIEF DESCRIPTION OF DRAWINGS

For more complete understanding of the present invention, and the advantage thereof, reference is now made to the subsequent descriptions taken in conjunction with the accompanying drawings, in which:

FIG. 1 is a schematic diagram illustrating a configuration of a medical support system;

FIG. 2 is a block diagram illustrating a configuration of a medical support device;

FIG. 3 is an illustrative diagram illustrating a configuration of a user information DB;

FIG. 4 is an illustrative diagram illustrating a configuration of a path template information DB;

FIG. 5 is an illustrative diagram illustrating a configuration of a clinical path information DB;

FIG. 6 is an illustrative diagram illustrating a configuration of clinical path information;

FIG. 7 is an illustrative diagram illustrating a configuration of a material correspondence information DB;

FIG. 8 is a block diagram illustrating a functional configuration of a medical support device;

FIG. 9 is an illustrative diagram of a functional block that performs analysis of introduction effects;

FIG. 10 is an illustrative diagram illustrating a configuration of a clinical path display screen;

FIG. 11 is an illustrative diagram illustrating a configuration of a medical care information input screen;

FIG. 12 is an illustrative diagram illustrating a configuration of an introduction effect display screen; and

FIG. 13 is a flowchart illustrating an analysis procedure of introduction effects.

### DESCRIPTION OF THE PREFERRED EMBODIMENTS

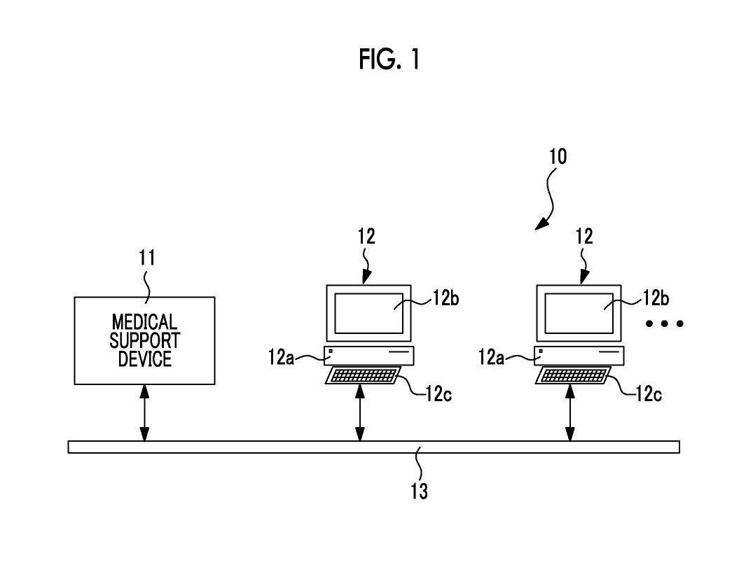

A medical support system 10 illustrated in FIG. 1 is a computer system that manages clinical path information so that medical staffs such as doctors and nurses can share the clinical path information. This medical support system 10 is installed in a medical institution such as a hospital. The clinical path is a medical care schedule table in a chart form that represents standardized medical care content for each disease. Since a plurality of medical care scheduled items for medical examination, treatment, and test are set in the clinical path along a time axis according to a type of disease in advance, it is possible to easily create a medical care schedule of a patient.

The medical support system 10 includes a medical support device 11 that manages the clinical path information, and a plurality of client terminals 12 used for, for example, viewing of the clinical path information. The medical support device 11 and the client terminals 12 are connected by a network 13 built by an intranet.

The medical support device 11 is, for example, a desktop type personal computer in which an application program for performing management of the clinical path information has been installed. The medical support device 11 is installed in, for example, an information processing room of a medical institution. The medical support device 11 has a function of receiving login or logout from the client terminal 12, a function of creating, updating, and deleting the clinical path information in response to a request from the client terminal 12, and a function of analyzing effects of introduction of the medical material. Further, the medical support device 11 has, for example, a function of creating a clinical path display screen in which the clinical path information is displayed, and an introduction effect display screen in which introduction effects of a medical material is displayed, and distributing the screen to the client terminal 12. The medical material refers to various medical devices, medical products, or drugs.

The client terminal 12 is, for example, a desktop type personal computer in which an application program used for viewing of the clinical path information has been installed. A plurality of client terminals 12 are installed, for example, in each medical care department or each medical care room, and are used, for example, for the medical staffs such as doctors and nurses to view the clinical path information. The client terminal 12 includes a terminal body 12a including, for example, a CPU, a memory, and a data storage, a display 12b, and an input device 12c including a mouse or a keyboard. The client terminal 12 includes a function of logging in and out the medical support device 11, a function of requesting the medical support device 11 to, for example, create, update, and delete the clinical path information, and a function of requesting analysis of the effects of introduction of a medical material. Further, the client terminal 12 includes a function of displaying the clinical path display screen and the introduction effect screen distributed from the medical support device 11 on the display 12b, and a function of performing an updating operation for the clinical path information.

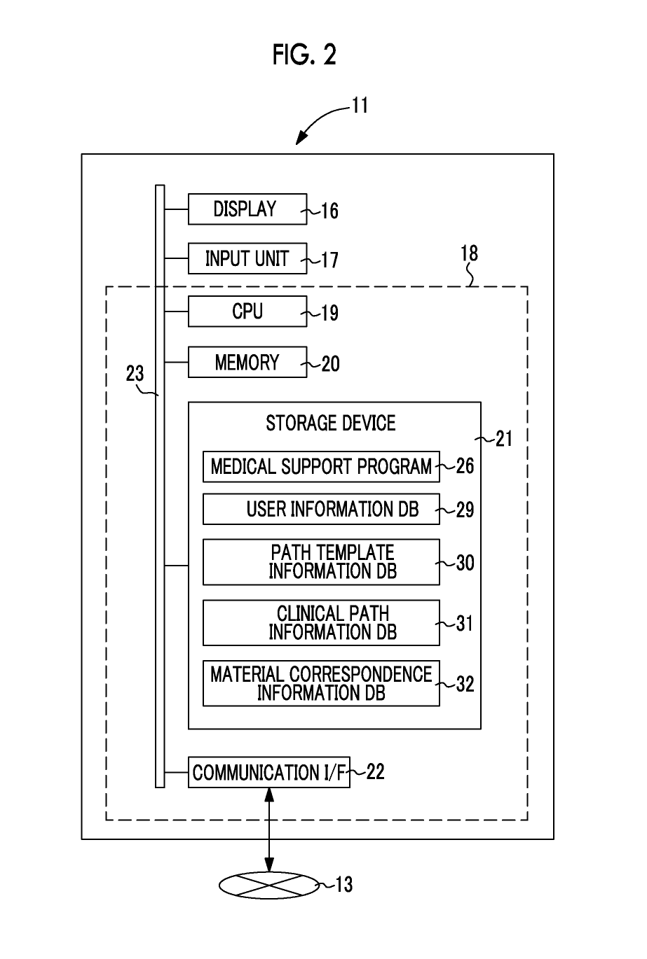

As illustrated in FIG. 2, the medical support device 11 is configured based on a computer such as a personal computer or a workstation. The medical support device 11 includes a display 16, an input unit 17 such as a keyboard and a mouse, and a computer main body 18. A CPU 19, a memory 20, a storage device 21, and a communication I/F 22 are provided in the computer main body 18, and are connected via a data bus 23.

The storage device 21 is a device that stores various data and includes, for example, a hard disk drive. Various programs such as an operating system (not illustrated) or a medical support program 26 for causing the computer to function as the medical support device 11 are stored in the storage device 21.

The memory 20 is a work memory used for the CPU 19 to execute a process. The CPU 19 loads the operating system stored in the storage device 21 into the memory 20, and executes the process according to the program to generally control each unit of the computer. The communication I/F 22 is a communication interface that connects to the network 13 and communicates with each client terminal 12.

Various databases (hereinafter, the database is referred to as DB), such as a user information database 29, a path template information DB 30, a clinical path information DB 31, and a material correspondence information DB 32, are also stored in the storage device 21.

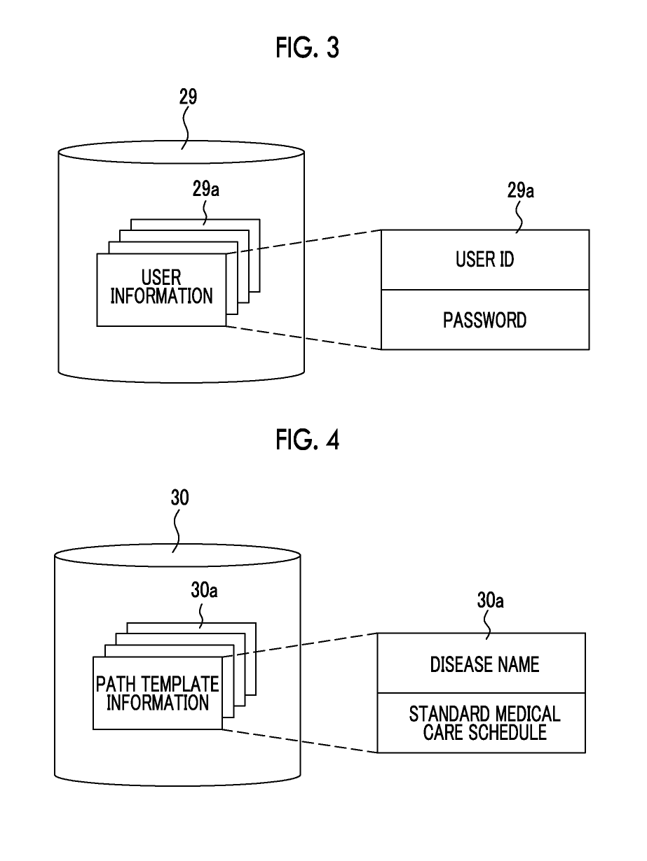

As illustrated in FIG. 3, user information 29a of a user capable of accessing the medical support device 11 is stored in a user information DB 29. A user ID and password are stored in in the user information 29a. The user ID is identification information of the user capable of accessing the medical support device 11. The password is used for authentication when the user logs in to the medical support device 11.

As illustrated in FIG. 4, a plurality of path template information 30a which are templates of the clinical path information are stored in the path template information DB 30. The path template information 30a is, for example, standardized for each disease such as illness or injury, including stroke, cancer, fracture, and burn. A name of the disease, and a standard medical care schedule in which a plurality of medical care scheduled items are set according to a type of disease are stored in the path template information 30a. Path template information of main diseases are prestored in the path template information DB 30, but new path template information may be created and registered by a medical institution in which the medical support system 10 is introduced.

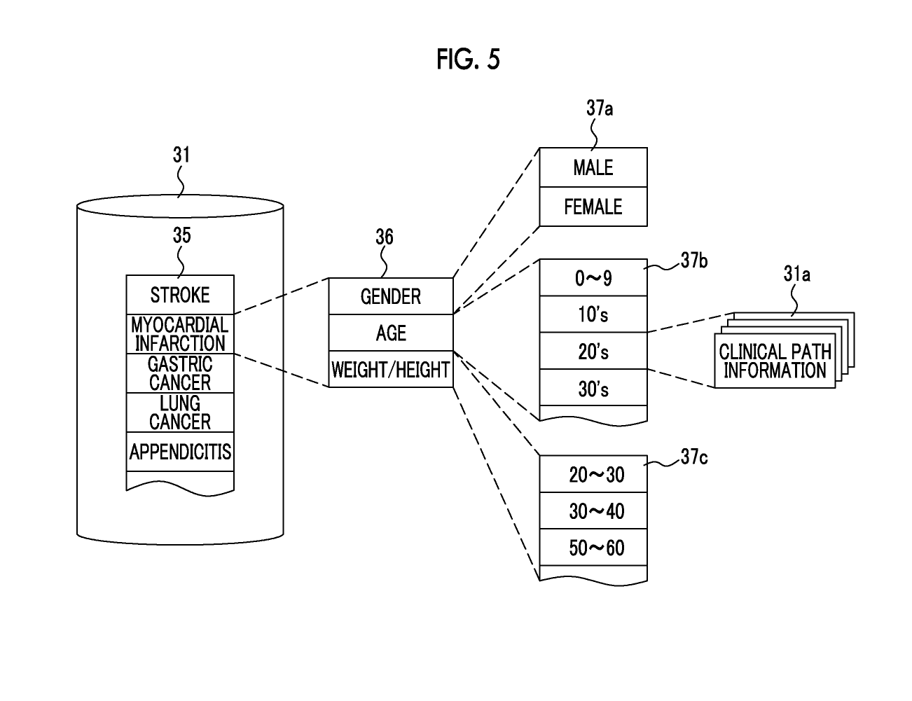

As illustrated in FIG. 5, the clinical path information DB 31 corresponds to a clinical path information storage unit of the present invention, and a plurality of clinical path information 31a created by the medical support device 11 is stored. In the clinical path information DB 31, a large number of the clinical path information 31a is classified into a large classification 35 for each disease, a middle classification 36 in which the large classification 35 is divided for each attribute of a patient, and small classifications 37a, 37b, and 37c in which the middle classification 36 is divided for each content of the attribute, and is managed. The large classification 35 is classified into diseases such as stroke, myocardial infarction, gastric cancer, and the like. In the middle classification 36, the large classification 35 is classified into gender, age, and body measurements. A body measurement value for classification is, for example, a ratio “weight/height” in view of a height of a causal relationship between a degree of obesity and disease. According to a type of disease, the classification may be classified into a blood pressure or a blood glucose level. The small classifications 37a to 37c are classifications in which each of middle classification 36 is classified into content thereof. For example, the middle classification “gender” is classified into small classifications “male” and “female”, and the middle classification “age” is classified into age, such as “10's” and “20's”.

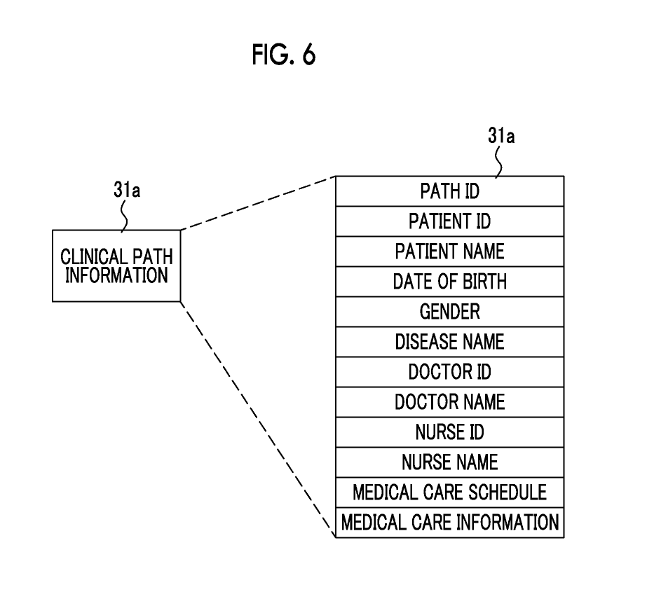

As illustrated in FIG. 6, a medical care schedule created based on the standard medical care schedule of the path template information 30a, medical care information on medical care performed on the patient, a path ID for identifying the clinical path information 31a, and patient information, doctor information, and nurses information input at the time of creation of clinical path information 31a are stored in the clinical path information 31a. The patient information includes, for example, a patient ID, a patient name, date of birth, a gender, and a disease name. The doctor information is a doctor ID and a doctor name. The nurse information is a nurse ID and a nurse name.

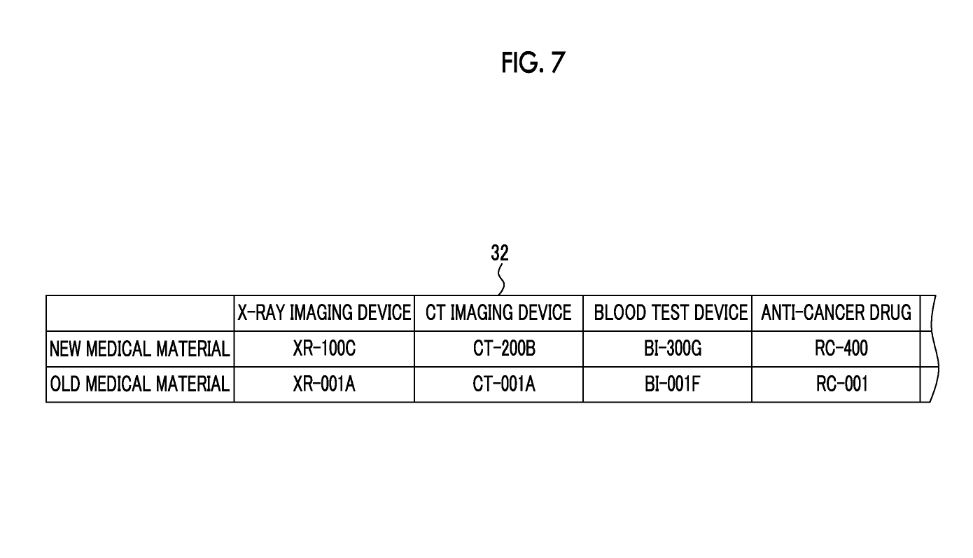

As illustrated in FIG. 7, the material correspondence information DB 32 corresponds to a material correspondence information storage unit of the present invention, and identification information of a newly introduced new medical material (first medical material) and an old medical material (second medical material) having the same function or purpose as the new medical material used prior to introduction of the new medical material are stored in association with each other. For example, model names “XR100C” and “XR001A” are stored as identification information in a new medical material and an old medical material of an “X-ray imaging device”. Similarly, a model name or a product name is stored as identification information in new medical materials and old medical materials of a “CT imaging device”, a “blood test device”, and an “anti-cancer drug”. Registration of the new medical material and the old medical material in the material correspondence information DB 32 is performed by a doctor or a nurse, an engineer who manages the medical support system 10, or the like when the new medical material is introduced.

When the clinical path information is created, a patient information DB, a staff information DB, or the like may be stored in the storage device 21 in order to simplify input of patient information or information on staffs such as doctors or nurses. Further, various databases such as the user information DB 29, the path template information DB 30, the clinical path information DB 31, and the material correspondence information DB 32 may be stored in an external data server connected to the medical support device 11.

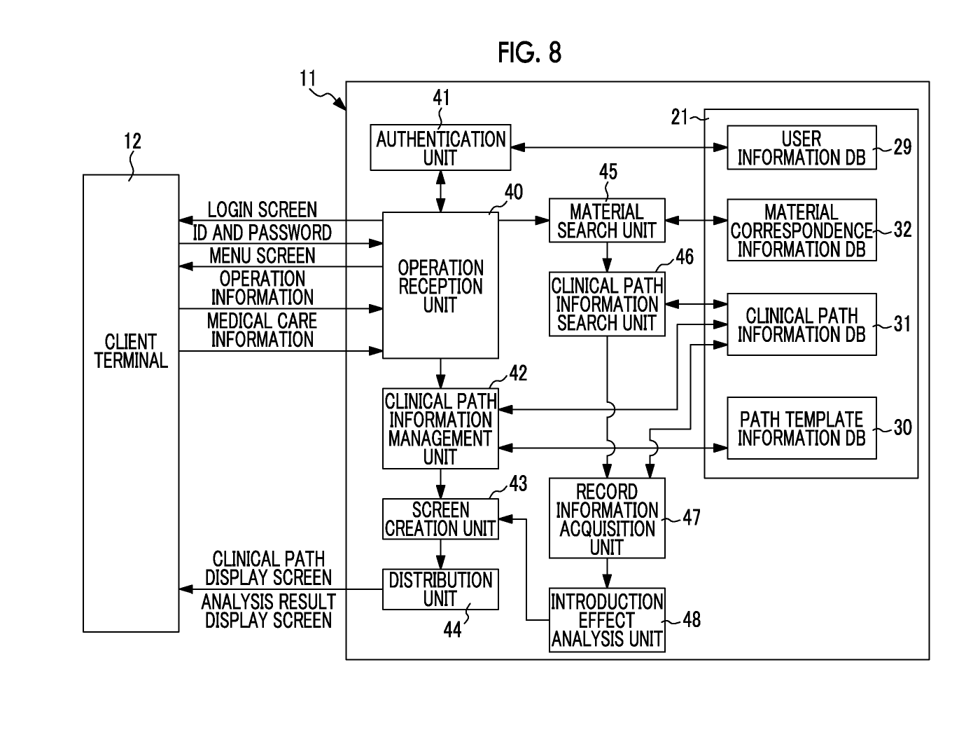

As illustrated in FIG. 8, when a medical support program 26 starts up, the CPU 19 of the medical support device 11 functions as an operation reception unit 40, an authentication unit 41, a clinical path information management unit 42, a screen creation unit 43, a distribution unit 44, a material search unit 45, a clinical path information search unit 46, a record information acquisition unit 47, and an introduction effect analysis unit 48 in cooperation with the memory 20.

The operation reception unit 40 receives various operations of the medical support device 11 by the client terminal 12. In a case in which the operation reception unit 40 receives a login request from the client terminal 12, the operation reception unit 40 distributes a login screen with an input field of a user ID and password to the client terminal 12 which is a request source. Further, the operation reception unit 40 receives the user ID and password input in the login screen.

The authentication unit 41 determines, through search, whether or not an ID and a password of the user input in the login screen exist in the user information DB 29. The authentication unit 41 authenticates the client terminal 12 in a case in which the input user ID and the input password are found from the user information DB 29, and transmits non-authentication notification without authenticating the client terminal 12 in a case in which the input user ID and the input password are not found.

In a case in which the client terminal 12 has logged in, the operation reception unit 40 distributes a menu screen in which operation buttons for creation, updating, deletion, viewing, or the like of the clinical path information 31a are provided, to the client terminal 12. If the menu screen is operated in the client terminal 12, an operation signal representing content of the operation is input to the operation reception unit 40.

In a case in which the creation button is operated in the menu screen, the operation reception unit 40 distributes a clinical path creation screen to the client terminal 12. Input fields of patient name and ID, date of birth, gender, name of disease, attendant doctor name and ID, attendant nurse name and ID, medical care start date, and the like are provided in the clinical path creation screen. Various information input in the clinical path creation screen is transmitted from the client terminal 12 to the medical support device 11 and input to the operation reception unit 40.

Further, in a case in which the updating button or the viewing button is operated in the menu screen, the operation reception unit 40 distributes a clinical path updating screen or a viewing screen to the client terminal 12. Input fields in which a path ID, a patient name and a patient ID, an attendant doctor name and doctor ID, an attendant nurse name and nurse ID, and the like can be input are provided in the clinical path updating screen or the viewing screen so that the clinical path information 31a can be searched for from the clinical path information DB 31 in various aspects. Various information input in the clinical path updating screen and the viewing screen is transmitted from the client terminal 12 to the medical support device 11 and input to the operation reception unit 40.

The operation reception unit 40 receives an updating operation from the client terminal 12 at the time of updating of the clinical path information 31a. For example, an input of medical care information on the medical care performed on the patient is included in this updating operation, in addition to change, addition, and deletion of the medical care scheduled item for the medical care schedule. Identification information of the new medical material or the old medical material used for medical care is also included in the input medical care information. Further, the operation reception unit 40 receives a selection of the new medical material of which the introduction effects are analyzed, and an analysis request in the clinical path display screen.

The clinical path information management unit 42 performs creation, updating, deletion, or the like of the clinical path information 31a. In a case in which the operation reception unit has received a creation request for the clinical path information 31a, the clinical path information management unit 42 creates the clinical path information 31a using the path template information 30a stored in the path template information DB 30 based on various information input to the clinical path creation screen. The created clinical path information 31a is stored in the clinical path information DB 31 and classified based on the disease name and the patient attribute.

In a case in which the operation reception unit 40 has received an updating request for the clinical path information 31a, the clinical path information management unit 42 searches the clinical path information DB 31 based on various information input to the clinical path updating screen, reads the created clinical path information 31a, and updates the clinical path information 31a according to the updating operation from the client terminal 12. The updated clinical path information 31a is stored in the clinical path information DB 31.

Further, in a case in which the operation reception unit 40 has received a viewing request for the clinical path information 31a, the clinical path information management unit 42 searches the clinical path information DB 31 based on various information input to the clinical path viewing screen, and reads the created clinical path information 31a.

The screen creation unit 43 performs creation of a clinical path display screen and an introduction effect display screen. In a case in which the operation reception unit 40 has received a creation request for the clinical path information 31a, the screen creation unit 43 creates the clinical path display screen based on the created clinical path information 31a. Further, in a case in which the operation reception unit 40 has received an updating request or a viewing request for the clinical path information 31a, the screen creation unit 43 creates a clinical path display screen based on the created clinical path information 31a. In a case in which the operation reception unit 40 has received an analysis request for introduction effects of the new medical material, the screen creation unit 43 creates the introduction effect display screen based on the analysis result.

The distribution unit 44 is a screen distribution unit and an analysis result distribution unit of the present invention, and distributes the clinical path display screen and the introduction effect display screen created by the screen creation unit 43 to the client terminal 12 over the network 13. For example, in a case in which the same clinical path information 31a and the same introduction effect display screen are viewed in a plurality of client terminals 12, the distribution unit 44 distributes the same clinical path display screen and the same introduction effect display screen to the respective client terminals 12. Further, in a case in which different clinical path information 31a and different introduction effect display screens are viewed in a plurality of client terminals 12, the distribution unit 44 distributes the different clinical path display screens and different introduction effect display screens to the respective client terminals 12.

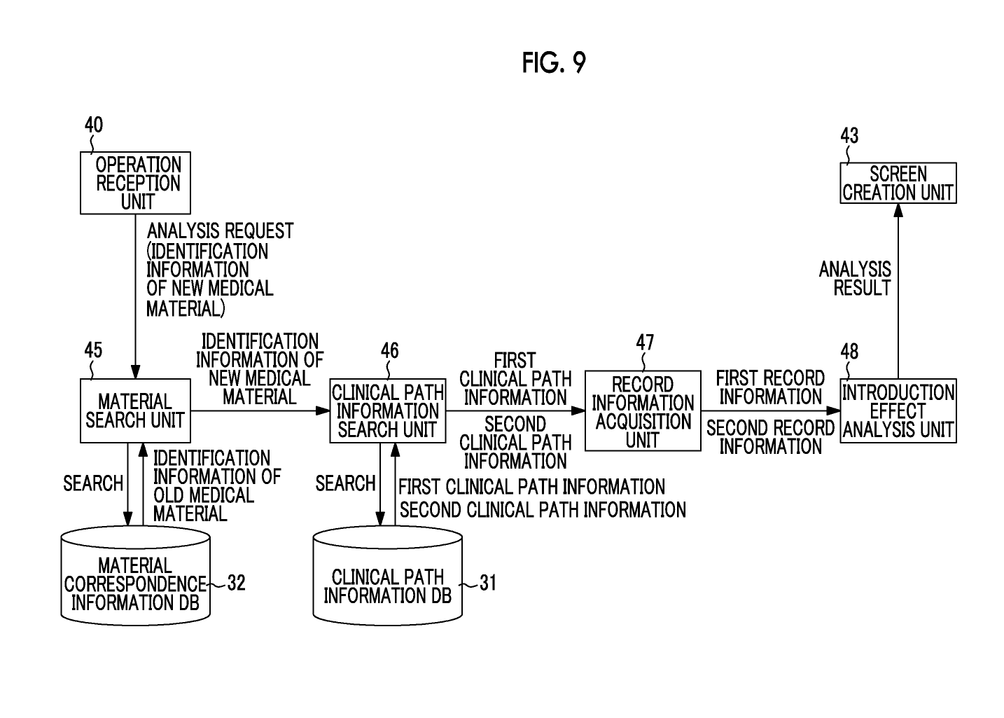

The material search unit 45, the clinical path information search unit 46, the record information acquisition unit 47, and the introduction effect analysis unit 48 are used to analyze the effects of introduction of a new medical material. As illustrated in FIG. 9, in a case in which the operation reception unit 40 receives an analysis request for the introduction effects of the new medical material, the material search unit 45 searches the material correspondence information DB 32, and specifies the old medical material corresponding to the identification information of the new medical material included in the analysis request. For example, in a case in which the identification information of the new medical material included in the analysis request is “XR-100C” of the X-ray imaging device, the old medical material “XR-001A” corresponding thereto is specified.

The clinical path information search unit 46 searches for the first clinical path information in which the new medical material included in the analysis request is used for medical care, and the second clinical path information in which the old medical material searched for by the material search unit 45 is used for medical care from the clinical path information DB 31. This search is performed for each of the large classification 35, the middle classification 36, and the small classification 37 of the clinical path information 31a. Accordingly, in a case in which the new medical material and the old medical material are used for a plurality of diseases such as stroke, myocardial infarction, and gastric cancer, the first clinical path information and the second clinical path information are searched for the middle classification 36 and the small classification 37 of each large classification 35 for each large classification 35 corresponding to each disease.

The record information acquisition unit 47 acquires first record information and second record information indicating treatment effects of the new medical material and the old medical material from the first clinical path information and the second clinical path information that have been searched for. For example, the number of days of hospitalization of the patient is used as the first record information and the second record information. The record information acquisition unit 47 specifies hospitalization date and discharge date from the medical care schedule of the first clinical path information and the second clinical path information, and acquires the number of days of the hospitalization from the hospitalization date to the discharge date as the first record information and the second record information. The acquisition of the first record information and the second record information is performed for each of the large classification 35, the middle classification 36, and the small classification 37 of the clinical path information 31a.

The introduction effect analysis unit 48 compares the first record information with the second record information to analyze the effects of introduction of the new medical material. Specifically, the introduction effect analysis unit 48 calculates an average of the first record information and the second record information, that is, the average number of days of hospitalization for each of the large classification 35, the middle classification 36, and the small classification 37 of the clinical path information 31a. Then, the introduction effect analysis unit 48 divides the average number of days of hospitalization of the old medical material by the average number of days of hospitalization of the new medical material, and calculates a rate of decrease in the average number of days of hospitalization of the new medical material to the old medical material as the effects of introduction of the new medical material. Results of the analysis of the introduction effect analysis unit 48 are input to the screen creation unit 43.

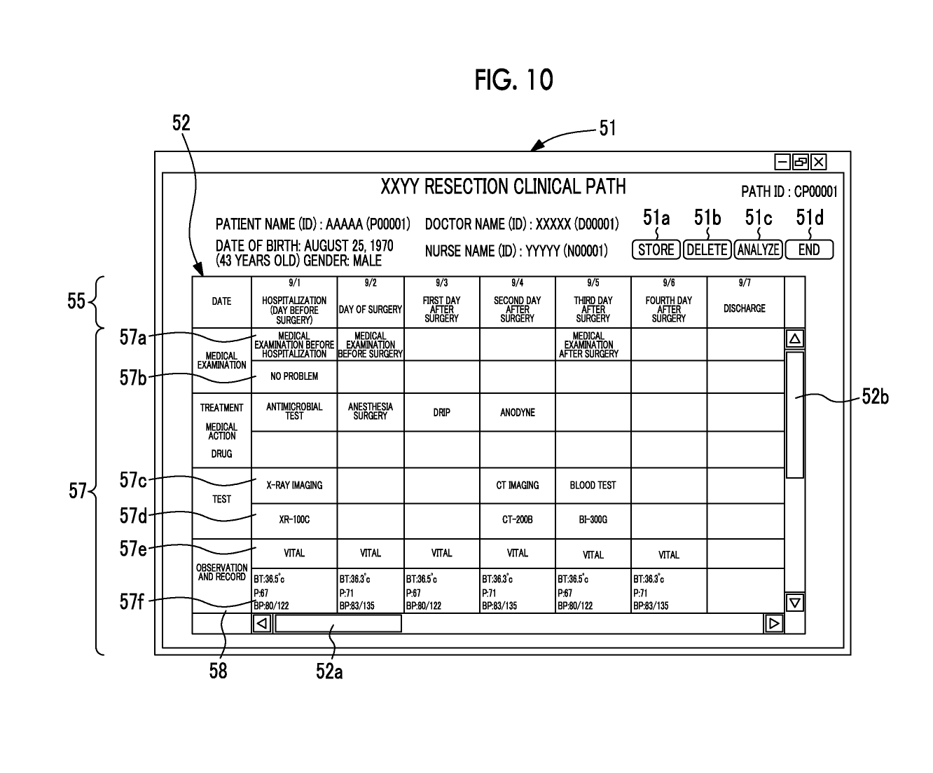

As illustrated in FIG. 10, a medical care schedule table 52 in a chart format is displayed on the clinical path display screen 51. A path ID for identifying the clinical path information 31a, a patient name and ID, date of birth and gender of the patient, a doctor name and ID, and a nurse name and ID are displayed in an upper portion of the clinical path display screen 51. The clinical path display screen 51 is operated by the input device 12c of the client terminal 12.

A storage button 51a, a deletion button 51b, an analysis button 51c, and an end button 51d are provided in an upper right portion of the clinical path display screen 51. The storage button 51a is operated in a case in which the clinical path information 31a displayed on the clinical path display screen 51 is stored in the clinical path information DB 31. The deletion button 51b is operated in a case in which the clinical path information 31a displayed on the clinical path display screen 51 is deleted from the clinical path information DB 31. The end button 51d is operated in a case in which end is performed without storing the clinical path information 31a displayed on the clinical path display screen 51 in the clinical path information DB 31. The analysis button 51c is operated when the effects of introduction of a new medical material is analyzed.

The medical care schedule table 52 is a schedule table in a chart form in which a plurality of medical care scheduled items are arranged along a time axis arranged on a horizontal axis. A plurality of date fields 55 in which date on which the medical care of the patient is performed and a medical care situation of the patient on that date are recorded are provided in the time axis. The medical care situation represents the progress of the medical care, such as “hospitalization (day before surgery)”, “day of surgery”, “N number of days after surgery”, and “hospital discharge”.

Under each date field 55, a plurality of medical care item fields 57 are provided in which medical care scheduled items set for each disease according to the standard medical care schedule of the path template information 30a and the medical care information on the performed medical care are provided. This medical care item fields 57 are divided into, for example, a plurality of medical care items such as “medical examination”, “treatment, medical action, and drug”, “test”, and “observation and record”, as illustrated in a plurality of heading fields 58 to the left. Each medical care item field 57 is divided into two upper and lower stages. The upper stage is the scheduled item field in which the medical care scheduled items are displayed, and the lower stage is a medical care information field in which the medical care information is displayed.

For example, the medical care scheduled item “medical examination before hospitalization” is displayed in a scheduled item field 57a of the medical care item field 57 corresponding to the medical care situation “hospitalization (day before surgery)” and the medical care item “medical examination”, and medical care information “no problem” which is a result of the medical examination before hospitalization is displayed in a medical care information field 57b. The medical care scheduled item “X-ray imaging” is displayed in a scheduled item field 57c of the medical care item field 57 corresponding to the medical care situation “hospitalization (day before surgery)” and the medical care item “test”, and medical care information, a model name “XR100C” of the new medical material used for X-ray imaging, is displayed in a medical care information field 57d. Further, a medical care scheduled item “vital” is displayed in a scheduled item field 57e of a medical care item field 57 corresponding to the “hospitalization (day before surgery)” of the medical situation and “observation and record” of the medical care item, and vital data such as body temperature (BT), pulse rate (P), and blood pressure (BP) is displayed in the medical care information field 57f. Thus, a model name of the medical material used for medical care is also displayed in the medical care information field, in addition to the medical care result.

Since the medical care schedule table 52 can be scrolled in a horizontal direction by a scroll bar 52a provided in a lower portion, it is possible to cope with disease with a large number of medical care days. Further, since the medical care schedule table 52 can be scrolled in a vertical direction by a scroll bar 52b provided at a right end, it is possible to cope with disease with a large number of medical care scheduled items. Therefore, in a case in which there are further medical care item fields under “observation and record”, it is possible to review all the medical care item fields by scrolling the medical care schedule table 52.

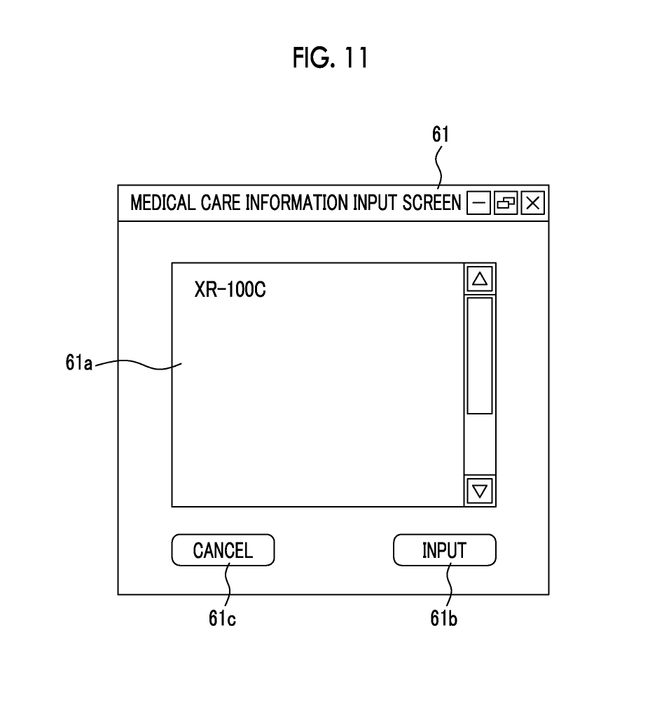

A medical care scheduled item and medical care information from the client terminal 12 can be input to the scheduled item field and the medical care information field of each medical care item field 57. When the medical care information field is double-clicked with a mouse constituting the input device 12c of the client terminal 12, the medical care information input screen 61 illustrated in FIG. 11 is displayed on the clinical path display screen 51. An input field 61a to which the medical care information is input, an input button 61b for instructing input execution, and a cancel button 61c for instructing input stop are provided in the medical care information input screen 61. If the medical care information is input to the input field 61a and the input button 61b is operated, the display of the medical care information input screen 61 ends, and the input medical care information is displayed in the selected medical care information field of the clinical path display screen 51.

Further, although not illustrated in detail, it is possible to input the medical care scheduled item in the scheduled item field of each medical care item fields 57 in the same procedure as the medical care information field. In a case in which the medical care scheduled item based on the standard medical care schedule is input to the scheduled item field in advance, it is possible to correct or delete the medical care scheduled item.

In a case in which the effects of introduction of a new medical material is analyzed, a medical care information field in which identification information of the new medical material is displayed on the clinical path display screen 51 is selected by the mouse, and the analysis button 51c on an upper right portion of the screen is operated. Then, analysis of the effects of introduction of the selected new medical material is performed by the material search unit 45, the clinical path information search unit 46, the record information acquisition unit 47, and the introduction effect analysis unit 48 described above, and an introduction effect display screen is created by the screen creation unit 43.

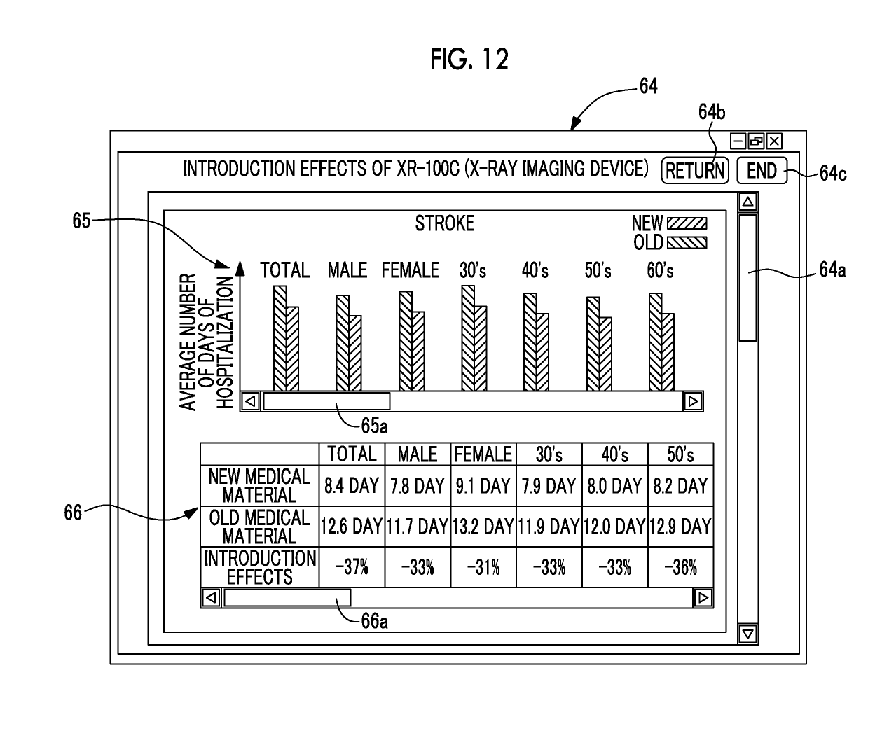

FIG. 12 is an example of the introduction effect display screen 64. The effects of introduction of the identification information “XR-100C” of the X-ray imaging device displayed in the medical care information field 57d in the clinical path display screen 51 is displayed. The introduction effect display screen 64 displays the introduction effects using a graph 65 and a table 66 for each classification of the clinical path information DB 31. While only the effects of introduction of “stroke” of the large classification 35 is displayed on FIG. 12, effects of introduction of the other large classification 35, such as “myocardial infarction” or “gastric cancer” can be displayed by operating a scroll bar 64a to the right of the screen and scrolling the screen downward.

The graph 65 is a bar graph in which an average number of days of hospitalization and each classification are set in a vertical axis and a horizontal axis. The average numbers of days of hospitalization for the new medical material and the old medical material input from the introduction effect analysis unit 48 is displayed for each of the large classification 35, the middle classification 36, and the small classification 37 of the clinical path information 31a. Further, a scroll bar 65a for scrolling the graph 65 in a horizontal direction is provided in a lower portion of the graph 65 so that the effects of the introduction of each of a large number of classifications can be displayed.

In the table 66, the new medical material, the old medical material, and the introduction effects are set on a vertical axis, and each classification is set on a horizontal axis. The average number of days of hospitalization of each classification input from the introduction effect analysis unit 48 is displayed in a cell corresponding to each classification of the new medical material and the old medical material of the table 66. Further, a rate in a decrease the average number of days of hospitalization for the new medical material to the old medical material, which is obtained by dividing the average number of days of hospitalization of the old medical material by the average number of days of hospitalization for the new medical material, is displayed in a cell corresponding to the introduction effects. Further, a scroll bar 66a for scrolling the table 66 in a horizontal direction is provided in a lower portion of the table 66 so that the effects of the introduction of each of a large number of classifications can be displayed. Thus, in the introduction effect display screen 64, since the effects of introduction of the new medical material can be confirmed through the graph 65 and the table 66, it becomes easy to contrast or comparison of the introduction effects.

A button 64b for returning from the introduction effect display screen 64 to the original clinical path display screen 51 is provided in an upper right portion of the introduction effect display screen 64. Further, an end button 64c for ending, for example, viewing of the clinical path information is also provided adjacent to the button 64b.

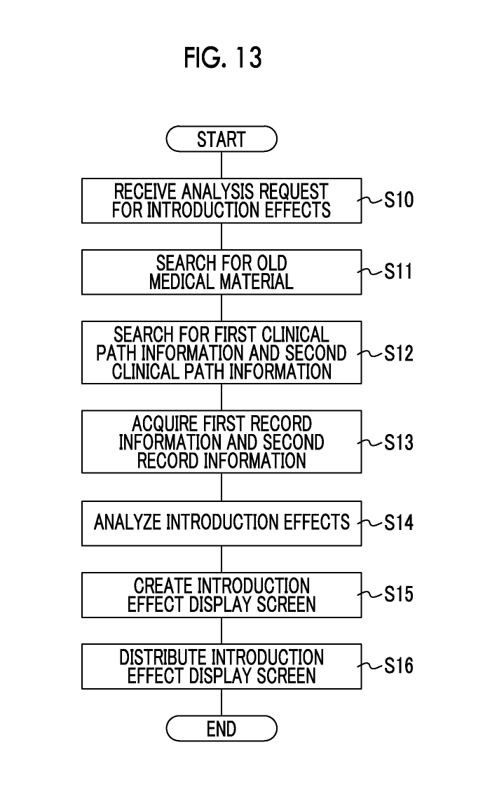

Next, an operation of the above embodiment will be described with reference to FIG. 13. If a medical care information field in which the identification information of the newly introduced new medical material is displayed is selected and the analysis button 51c is operated in the clinical path display screen 51 displayed on the client terminal 12, an analysis request including the identification information of the new medical material is transmitted from the client terminal 12 to the medical support device 11. This analysis request is received by the operation reception unit 40 (S10).

The material search unit 45 searches the material correspondence information DB 32, and specifies the old medical material corresponding to the identification information of the new medical material included in the analysis request (S11). The clinical path information search unit 46 searches for the first clinical path information in which the new medical material included in the analysis request is used for medical care, and the second clinical path information in which the old medical material searched for by the material search unit 45 is used for medical care from the clinical path information DB 31 for each of the large classification 35, the middle classification 36 and, the small classification 37 of the clinical path information DB 31 (S12).

The record information acquisition unit 47 acquires the number of days of hospitalization representing treatment effects of the new medical material and the old medical material as the first record information and the second record information from the first clinical path information and the second clinical path information that have been searched for (S13). The introduction effect analysis unit 48 analyzes the introduction effects of the new medical material for each of the large classification 35, the middle classification 36, and the small classification 37 of the clinical path information DB 31 (S14). Specifically, the introduction effect analysis unit 48 calculates an average of each of the first record information and the second record information, that is, each of average numbers of days of hospitalization, and divides the average number of days of hospitalization of the old medical material by the average number of days of hospitalization of the new medical material to calculate a rate of a decrease in the average number of days of hospitalization of the new medical material to the old medical material as introduction effects of the new medical material.

The screen creation unit 43 creates the introduction effect display screen 64 based on the analysis result of the introduction effect analysis unit 48 (S15). The distribution unit 44 distributes the created introduction effect display screen 64 to the client terminal 12 (S16).

According to the above embodiment, it is possible to acquire treatment effects of the newly introduced new medical material and treatment effects of the old medical material used prior to introduction of the new medical material from the clinical path information 31a, and analyze the effects of introduction of the new medical material by comparing the acquired treatment effects. In the clinical path information 31a, since content of the medical care scheduled item or the medical care schedule is changed due to the introduction of the new medical material, it is possible to analyze accurate introduction effects of the new medical material by using treatment effects acquired from the clinical path information 31a. The analyzed introduction effects can be referred to, for example, when it is determined whether the introduction results are good or when a new medical material is introduced.

While the clinical path information DB 31 is classified into the large classification 35 of each disease, the middle classification 36 for each patient attribute, and the small classification 37 of each content of the attribute in advance, and the introduction effects are analyzed for each classification in the above embodiment, the clinical path information 31a may be stored in the clinical path information DB 31 without being classified. In this case, when the analysis of the introduction effects is requested, the large classification 35, the middle classification 36, and the small classification 37 described above may be designated as analysis conditions and the analysis may be performed according to the analysis conditions.

While the number of days of hospitalization has been used as the record information representing the treatment effects, the number of days of hospital visit, a test value for medical test, or the like may be used. Further, while the ratio of the weight/height has been used as a body measurement value for classifying the clinical path information, a blood pressure, a blood glucose level, and other test values may be used as classification items according to disease.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. The medical support device comprising:
a material correspondence information storage unit in which identification information of a first medical material and identification information of a second medical material used prior to introduction of the first medical material are stored in association with each other;
a clinical path information storage unit in which clinical path information including a medical care schedule of a patient, medical care information on medical care performed on the patient, and the identification information of the first medical material or the second medical material used for the medical care as one of the medical care information is stored;
an operation reception unit that receives an analysis request of introduction effects of the first medical material on a clinical path display screen on which the medical care schedule, the medical care information, and the identification information of the first medical material as one of the medical care information are displayed;
a material search unit that searches for the second medical material corresponding to the first medical material received by the operation reception unit from the material correspondence information storage unit;
a clinical path information search unit that searches for first clinical path information in which the first medical material received by the operation reception unit is used for medical care, and second clinical path information in which the second medical material searched for by the material search unit is used for medical care from the clinical path information storage unit;
a record information acquisition unit that acquires first record information and second record information indicating treatment effects of the first medical material and the second medical material from the first clinical path information and the second clinical path information; and
an introduction effect analysis unit that compares the first record information with the second record information to analyze the effects of introduction of the first medical material.

2. The medical support device according to claim 1,
wherein the clinical path information is classified for each disease name or attribute of the patient in the clinical path information storage unit,
the clinical path information search unit searches for the first clinical path information and the second clinical path information for each attribute,
the record information acquisition unit acquires the first record information and the second record information for each attribute, and
the introduction effect analysis unit analyzes the effects of introduction of the first medical material for each attribute.

3. The medical support device according to claim 1,
wherein the first record information and the second record information are any one of the number of days of hospitalization, the number of days of hospital visit, and a test value of medical test performed on the patient.

4. The medical support device according to claim 3,
wherein the introduction effect analysis unit divides the second record information by the first record information to obtain the effects of introduction of the first medical material relative to the second medical material.

5. The medical support device according to claim 2,
wherein the attribute of the patient includes at least one of gender, age, and a body measurement value.

6. The medical support device according to claim 1, further comprising a screen creation unit that creates the clinical path display screen and an introduction effect display screen on which introduction effects of the first medical material are displayed.

7. The medical support device according to claim 6,
wherein the screen creation unit creates a graph in which the first record information and the second record information are compared with each other, and displays the graph on the introduction effect display screen.

8. The medical support device according to claim 7,
wherein the screen creation unit displays values of the first record information and the second record information together with the graph.

9. The medical support device according to claim 6, further comprising a distribution unit that distributes the clinical path display screen and the introduction effect display screen to a client terminal connected over a network.

10. A method for controlling a medical support device that analyzes effects of introduction of a first medical material through a comparison with a second medical material used prior to the introduction of the first medical material, the method comprising:
an operation reception step of receiving an analysis request of the introduction effects of the first medical material on a clinical path display screen on which clinical path information including a medical care schedule of a patient, medical care information on medical care performed on the patient, and identification information of the first medical material or the second medical material used for the medical care as one of the medical care information is displayed;
a material search step of searching for the second medical material corresponding to the first medical material received in the operation reception step from a material correspondence information storage unit in which identification information of the first medical material and identification information of the second medical material are stored in association with each other;
a clinical path information search step of searching for first clinical path information in which the first medical material received in the operation reception step is used for medical care, and second clinical path information in which the second medical material searched for in the material search step is used for medical care, from a clinical path information storage unit in which the clinical path information is stored;
a record information acquisition step of acquiring first record information and second record information indicating treatment effects of the first medical material and the second medical material from the first clinical path information and the second clinical path information; and
an introduction effect analysis step of comparing the first record information with the second record information to analyze the effects of introduction of the first medical material.

11. The method for controlling a medical support device according to claim 10,
wherein the clinical path information is classified for each disease name or attribute of the patient in the clinical path information storage unit,
the clinical path information search step searches for the first clinical path information and the second clinical path information for each attribute,
the record information acquisition step acquires the first record information and the second record information for each attribute, and
the introduction effect analysis step analyzes the effects of introduction of the first medical material for each attribute.

12. A medical support system including a medical support device that analyzes effects of introduction of a first medical material through a comparison with a second medical material used prior to the introduction of the first medical material, and a client terminal connected to the medical support device over a network, the medical support device comprising:
a material correspondence information storage unit in which identification information of the first medical material and identification information of the second medical material are stored in association with each other;
a clinical path information storage unit in which clinical path information including a medical care schedule of a patient, medical care information on medical care performed on the patient, and the identification information of the first medical material or the second medical material used for the medical care as one of the medical care information is stored;
a screen distribution unit that distributes a clinical path display screen on which the medical care schedule, the medical care information, and the identification information of the first medical material as one of the medical care information are displayed, to the client terminal;
an operation reception unit that receives an analysis request of the introduction effects of the first medical material through the clinical path display screen from the client terminal;
a material search unit that searches for the second medical material corresponding to the first medical material received by the operation reception unit from the material correspondence information storage unit;
a clinical path information search unit that searches for first clinical path information in which the first medical material received by the operation reception unit is used for medical care, and second clinical path information in which the second medical material searched for by the material search unit is used for medical care from the clinical path information storage unit;
a record information acquisition unit that acquires first record information and second record information indicating treatment effects of the first medical material and the second medical material from the first clinical path information and the second clinical path information;
an introduction effect analysis unit that compares the first record information with the second record information to analyze the effects of introduction of the first medical material; and
an analysis result distribution unit that distributes results of the analysis of the introduction effects to the client terminal.

13. The medical support system according to claim 12,
wherein the clinical path information is classified for each disease name or attribute of the patient in the clinical path information storage unit,
the clinical path information search unit searches for the first clinical path information and the second clinical path information for each attribute,
the record information acquisition unit acquires the first record information and the second record information for each attribute, and
the introduction effect analysis unit analyzes the effects of introduction of the first medical material for each attribute.
